(19) United States
(12) Patent Application Publication
(10) Pub. No.: US 2023/0098669 A1
(43) Pub. Date: Mar. 30, 2023

(54) Selective Dual-Wavelength Olefin Metathesis Polymerization for Additive Manufacturing

(71) Applicant: National Technology & Engineering Solutions of Sandia, LLC, Albuquerque, NM (US)

(72) Inventors: Samuel Carlos Leguizamon, Albuquerque, NM (US); Jeffrey Clayton Foster, Albuquerque, NM (US); Adam W. Cook, Albuquerque, NM (US); Leah Appelhans, Tijeras, NM (US); Erica M. Redline, Albuquerque, NM (US); Brad Howard Jones, Albuquerque, NM (US)

(21) Appl. No.: 17/900,584

(22) Filed: Aug. 31, 2022

Related U.S. Application Data
(60) Provisional application No. 63/250,059, filed on Sep. 29, 2021.

(51) Int. Cl. C08F 136/20

(52) U.S. Cl. CPC C08F 136/20

(57) ABSTRACT

The invention is directed to the selective dual wavelength olefin metathesis polymerization for additive manufacturing. Dual-wavelength stereolithographic printing uses ring-opening metathesis polymerization of the metathesis-active polymers. As an example, a resin formulation based on dicyclopentadiene was produced using a photolatent olefin metathesis catalyst, various photosensitizers and photobase generators to achieve efficient initiation by light at one wavelength (e.g., blue) and fast catalyst decomposition and polymerization deactivation by light at a second wavelength (e.g., ultraviolet). This process enables 2-dimensional stereolithographic printing, either using photomasks or with patterned, collimated light. Importantly, the same process was readily adapted for 3-dimensional continuous additive manufacturing, with printing rates of up to 36 mm h⁻¹ for patterned light and up to 180 mm h⁻¹ using un-patterned, high intensity light.

### CROSS-REFERENCE TO RELATED APPLICATION

This application also claims the benefit of U.S. Provisional Appl. No. 63/250,059, filed Sep. 29, 2021, which is incorporated herein by reference.

### Statement Regarding Prior Disclosures by the Inventor or a Joint Inventor

The following disclosure is submitted under 35 U.S.C. 102(b)(1)(A): Jeffrey C. Foster, Adam W. Cook, Nicolas T. Monk, Brad H. Jones, Leah N. Appelhans, Erica M. Redline, Samuel C. Leguizamon, “Continuous Additive Manufacturing using Olefin Metathesis,” Advanced Science 9(14), 2200770 (2022). The subject matter of this disclosure was conceived of or invented by the inventors named in this application.

### STATEMENT OF GOVERNMENT INTEREST

This invention was made with Government support under Contract No. DE-NA0003525 awarded by the United States Department of Energy/National Nuclear Security Administration. The Government has certain rights in the invention.

### FIELD OF THE INVENTION

The present invention relates to additive manufacturing and, in particular, to selective dual wavelength olefin metathesis polymerization for additive manufacturing.

### BACKGROUND OF THE INVENTION

The remarkable flexibility of three-dimensional (3D) printing technologies enables rapid production of complex objects with designed internal features. Collectively referred to as additive manufacturing (AM), this suite of techniques is ideally suited for prototyping and customized manufacturing and has been leveraged for the fabrication of products ranging from medical devices to made-to-order athletic wear to aerospace components. See S. H. Huang et al., Int. J. Adv. Manuf. Technol. 67, 1191 (2013); H. N. Chia and B. M. Wu, J. Biol. Eng. 9, 4 (2015); Q. Liu et al., Int. J. Adv. Manuf. Technol. 29, 317 (2006); C. L. Ventola, Pharm. Ther. 39, 704 (2014); T. Wohlers and T. Caffrey, Manuf. Eng. 150, 67 (2013); J. Manyika et al., Disruptive technologies: Advances that will transform life, business, and the global economy, Vol. 180, McKinsey Global Institute San Francisco, Calif. (2013). In particular, vat polymerization AM techniques, such as stereolithography (SLA), have found broad industrial use. See X. L. Ma, Appl. Mech. Mater. 401, 938 (2013). During conventional SLA, a 3D object is produced layer wise through a series of cross-sectional curing steps using a photopolymerizable resin. The shape of the resulting object is determined by the pattern of the incident light, and thus the potential geometry space for objects produced by SLA is vast. However, SLA and related methods rely, almost exclusively, on free radical polymerization (FRP) chemistry, limiting the diversity of available monomers (e.g., acrylates) and thus material properties. See A. C. Uzcategui et al., Adv. Eng. Mater 20, 1800876 (2018); M. Layani et al., Adv. Mater. 30, 1706344 (2018); G. Taormina et al., J. Appl. Biomater. Funct. Mater. 16, 151 (2018); P. Xiao et al., Prog. Polym. Sci. 41, 32 (2015); C. Decker and K. Zahouily, Polym. Degrad. Stab. 64, 293 (1999); and M. B. A. Tamez and I. Taha, Addit. Manuf. 37, 101748 (2021).

An additional limitation of SLA printing is the time-consuming delamination and recoating steps between each printed layer, restricting printing speed to millimeters or centimeters per hour. See M. P. de Beer et al., Sci. Adv. 5, eaau8723 (2019). Continuous liquid interface production (CLIP) has addressed this limitation by creating a layer of inhibited polymerization within the photoresin that is adjacent to the projection window such that delamination and recoating is unnecessary. See J. R. Tumbleston et al., Science 347, 1349 (2015). More recently, dual-wavelength printing systems have been developed for FRP that employ photo-orthogonal initiation and inhibition chemistries to maximize printing speed (e.g., 2,000 mm/h). See M. P. de Beer et al., Sci. Adv. 5, eaau8723 (2019); and T. F. Scott et al., Science 324, 913 (2009). S. Deng et al., Adv. Mater. 31, 1903970 (2019).

### SUMMARY OF THE INVENTION

The present invention is directed to a photopolymerizable resin, comprising a metathesis-active monomer; a photolatent metathesis catalyst; a photosensitizer that initiates the latent metathesis catalyst upon irradiation with a first light at a first wavelength, thereby initiating the ring-opening metathesis polymerization of the metathesis-active monomer; and a photochemical deactivating species that deactivates the metathesis polymerization of the metathesis-active monomer upon irradiation with a second light at a second wavelength. As an example, the metathesis-active monomer can comprise dicyclopentadiene, norbornadiene, norbornene, oxonorbornene, azanorbornene, cyclobutene, cyclooctene, cyclooctadiene, cyclooctatetraene, or derivatives or comonomers thereof. As an example, the photolatent metathesis catalyst can comprise a ruthenium, tungsten, molybdenum, rhenium, or titanium-based catalyst. For example, the photosensitizer can comprise isopropylthioxanthone, camphorquinone, benzophenone, phenothiazine, benzil, Rose Bengal, rhodamine, anthracene, perylene, or coumarin. The resin can further comprise a co-initiator, such as ethyl-4-(dimethylamine) benzoate. For example, the photochemical deactivating species can comprise a photobase generator that reacts with the initiated metathesis catalyst upon irradiation with the second light at the second wavelength, thereby decomposing the metathesis catalyst and deactivating polymerization of the metathesis-active monomer. For example, the photobase generator can comprise an amine or phosphine. For example, the amine can comprise aniline, n-butylamine, cyclohexylamine, piperidine, or tetramethyl guanidine, or derivatives thereof. Alternatively, the photochemical deactivating species can comprise a photo-induced radical inhibitor, such as hexaarylbiimidazole or a derivative thereof.

The invention can be used with vat photopolymerization additive manufacturing or any other photopolymerization process that uses dual-wavelength ring-opening metathesis polymerization. For example, a method for photopolymerization-based additive manufacturing can comprise providing a vat of the photopolymerizable resin, irradiating the photopolymerizable resin with the first light at the first wavelength, wherein irradiation with the first light initiates the ring-opening metathesis polymerization of the metathesis-active monomer, and irradiating the photopolymerizable resin with the second light at the second wavelength thereby deactivating polymerization of the metathesis-active monomer, wherein the photopolymerizable resin is selectively irradiated with the first light and the second light so as to form a cured object. For example, the first light and/or the second light can be patterned, thereby providing patterned illumination of the photopolymerizable resin. The patterned first and/or second light can further provide a variable intensity image. The cured object can be continuously withdrawn from the vat of the photopolymerizable resin, thereby producing a three-dimensional object.

Continuous additive manufacturing using olefin metathesis employing a dual-wavelength photo-activation/photo-decomposition and deactivation approach was demonstrated. In addition to topologically complex objects produced using a selective wavelength photoresist approach, continuous SWOMP was developed to create complex, 3D objects using UV light in combination with patterned, multi-intensity blue light. Importantly, the addition of photosensitizer and photobase generator to a DCPD resin had no detrimental influence on the thermomechanical performance of the cured materials. Continuous printing rates were found to be competitive with existing continuous printing technologies based on FRP chemistry but substantially faster than traditional SLA. The wavelength selective chemistry may have broad implications for AM in terms of material and property selection and may inspire nascent dual-wavelength processes.

### BRIEF DESCRIPTION OF THE DRAWINGS

The detailed description will refer to the following drawings, wherein like elements are referred to by like numbers.

FIGS. 1A-1C illustrate selective dual-wavelength olefin metathesis polymerization (SWOMP) chemistry using HeatMet (HM) as the photolatent catalyst and dicyclopentadiene (DCPD) as the metathesis-active monomer. FIG. 1A shows irradiation with light at a first wavelength λ₁ initiates the catalyst via photosensitization. FIG. 1B shows generation of an amine base by photolysis of a photobase generator (PBG) by irradiation with light at a second wavelength λ₂ decomposes the catalyst and deactivates polymerization. FIG. 1C shows the formulation components used in an exemplary photoresin. PC=photocage; SIMes=1,3-Bis(2,4,6-trimethylphenyl)-4,5-dihydroimidazol-2-ylidene; CQ=camphorquinone; EDAB=ethyl-4-(dimethylamino) benzoate; TMG=1,1,3,3-tetramethyl guanidine; NPPOC=3-nitrophenylpropyloxycarbonyl; DCPD=dicyclopentadiene.

FIG. 2A is a generalized schematic illustration of photoinitiation and photo-decomposition chemistries promoted by blue or UV light, respectively. FIG. 2B shows UV-vis spectra demonstrating the photo-orthogonality of the photosensitization (CQ, light blue spectrum) and photo-decomposition (NPPOC-TMG, purple spectrum) chemistries employed. The light sources are relatively narrowband, so that they do not appreciably overlap at the initiation and deactivation wavelengths. Spectra were collected for the individual compounds at 0.01 mg mL⁻¹ in CH₂Cl₂ solution. FIG. 2C is a graph showing polymerization kinetics as measured by FT-IR spectroscopy at 1573 cm⁻¹ for optimized photoresin irradiated with 475 nm light in the absence of PBG (black circles) and with PBG at 475 nm (blue circles), 365 nm (purple circles), and both wavelengths (orange circles). FIG. 2D is a graph showing the evolution of modulus over time for the same resin formulation and irradiation wavelengths as in FIG. 2C. FIG. 2E is a graph showing polymerization deactivation by turning on the 365 nm light at different times (t=0, 45, 60, 75, 90, or 105 s) after initiation as compared to polymerization in the absence of 365 nm light (blue). The dashed vertical lines represent the time at which the 365 nm light was turned on with the various colors corresponding to the separate kinetic traces as measured by FT-IR. The 475 nm light was turned on at t=0 s and left on throughout the duration of the experiments. [DCPD]/[NPPOC-TMG]/[HM]=5000:10:1 was used for these experiments with 0.5 wt % CQ and 1 wt % EDAB.

FIG. 3A is a schematic illustration of a photopolymerization setup for single-wavelength ROMP, wherein patterned blue light was projected into the photopolymerizable resin from below. FIG. 3B is an optical photograph of pDCPD dogbones produced from the image shown above. FIG. 3C is a graph of dynamic mechanical analysis (DMA) of pDCPD films prepared via ROMP using the exemplary resin w/(blue circles) or w/o (black circles) 15 equiv of NPPOC-TMG relative to HM. FIG. 3D is a graph of measured tensile strengths (solid blue bars) and Young's moduli (cross-hatched purple bars) of dogbones prepared by photopolymerization using the exemplary resin and different amounts of NPPOC-TMG. FIG. 3E is a schematic illustration of a projector image and resulting cured staircase structure used to determine cure depths. FIG. 3F is a graph of measured cure depths obtained via photopolymerization by varying the projected light intensity and using exemplary DCPD resins containing 0 (black circles), 5 (purple circles), 10 (orange circles), or 15 (blue circles) equiv of NPPOC-TMG relative to HM. [DCPD]/[NPPOC-TMG]/[HM]=5000:15:1 was used for these experiments with 1 wt % CQ and 2 wt % EDAB.

FIG. 4A is a schematic illustration of a stereolithographic setup, wherein the photopolymerizable resin is illuminated with a constant background of blue light from below and patterned UV light from above. Resin curing is inhibited in the regions where the UV light is present. FIG. 4B shows optical photographs of a photomask and the corresponding cured resin obtained by this process.

FIG. 5A is a schematic illustration of a setup for intensity-patterned photopolymerization using dual-wavelength SWOMP, wherein patterned, gray-scaled blue light is superimposed with collimated UV light and projected into the photopolymerizable resin to create an object. FIG. 5B is a graph of deactivation height as a function of UV/blue light intensity ratio for resins formulated with 5 (purple circles), 10 (orange circles), or 15 equiv (blue circles) of NPPOC-TMG relative to HM. FIGS. 5C and 5D are multi-level intensity images and corresponding topographical images of printed objects. FIG. 5E is a graph of measured (blue circles) and expected (black line) heights for the surface features obtained for the object in FIG. 5D. The red line on the topographical image in FIG. 5D represents the profile path. Expected heights were calculated by subtracting the average deactivation height found in FIG. 5B from the spacer thickness (i.e., 635 μm) and lateral distances were scaled to match measured values. [DCPD]/[NPPOC-TMG]/[HM]=5000:15:1 was used for these experiments with 1 wt % CQ and 2 wt % EDAB.

FIGS. 6A-6C illustrate additional SWOMP of “National” text, showcasing the multi-dimensional precision of deactivation using multi-intensity blue light patterning. FIG. 6A is a multi-layer grayscale image and corresponding topographical image of tapered height “National” text. The grid represents 1 mm×1 mm squares. FIG. 6B is a grayscale representation of the relative blue light intensities projected. FIG. 6C is a graph of measured (blue circles) and expected (black line) heights for the surface features obtained for the object in FIG. 6A. The red line on the topographical image in FIG. 6A represents the profile path. Expected heights were calculated by subtracting the deactivation height found using an exponential fit of the deactivation data from the spacer thickness (i.e., 500 μm) and lateral distances were scaled to match measured values. [DCPD]/[NPPOC-TMG]/[HM]=5000:15:1 was used for these experiments with 1 wt % CQ and 2 wt % EDAB.

FIG. 7A is a schematic illustration of a setup for continuous SLA, wherein intensity patterned blue light is superimposed with collimated UV light and projected into the photopolymerizable resin and an object forms on the build head, which becomes progressively taller as the build head is withdrawn. FIG. 7B is a photograph of a Thunderbird object obtained using a continuous SWOMP projector setup at a printing rate of 36 mm h⁻¹. FIGS. 7C-7E are photographs of a cylindrical object obtained using a high-intensity lamp setup and a printing rate of 180 mm h⁻¹ during printing (FIG. 7C), immediately after printing (FIG. 7D), and inverted after removing from the printer (FIG. 7E). [DCPD]/[NPPOC-TMG]/[HM]=5000:15:1 was used for these experiments with 1 wt % CQ and 2 wt % EDAB.

FIGS. 8A and 8B show polymerization evolution of modulus over time for DCPD mixtures without and with hexaarylbiimidazole (HABI), respectively. Evolution of modulus was characterized by photo-rheology using distinct irradiation profiles (475 nm only, 365 nm only, and concurrent 475 and 365 nm irradiation). [DCPD]/HM]=2000:1 was used for these experiments with 1 wt % CQ, 2 wt % EDAB and 1 wt % HABI (if used).

### DETAILED DESCRIPTION OF THE INVENTION

The present invention is directed to the use of ring-opening metathesis polymerization (ROMP) coupled with dual-wavelength SLA additive manufacturing. Polymers produced by ROMP have a higher thermomechanical and chemical property ceiling compared to polyacrylates, and can be tailored to include sidechain and backbone heterogeneity in terms of configuration and composition. See S. Kovačič and C. Slugovc, Mater. Chem. Front. 4, 2235 (2020); J. C. Mol, J. Mol. Catal. A: Chem. 213, 39 (2004); A. K. Pearce et al., J. Polym. Sci. Part A: Polym. Chem. 57, 1621 (2019); J. P. Edwards et al., J. Polym. Sci. Part A: Polym. Chem. 57, 228 (2019); and S. C. Radzinski et al., ACS Macro Lett. 6, 1175 (2017). For example, analogues of polyethylene, polyurethane, polyamide, poly(acetylene), and poly(p-phenylene vinylidene) have all been prepared by ROMP of cyclic olefin monomers. See H. Martinez et al., Polym. Chem. 5, 3507 (2014); W. J. Neary and J. G. Kennemur, ACS Macro Lett. 8, 46 (2019); W. R. Gutekunst and C. J. Hawker, J. Am. Chem. Soc. 137, 8038 (2015); G. I. Peterson et al., Acc. Chem. Res. 52, 994 (2019); and T. W. Hsu et al., J. Polym. Sci. 60, 569 (2022). While photopolymerization strategies have been developed for ROMP, ROMP-based AM using decomposition/deactivation chemistry has yet to be reported. Therefore, the dual-wavelength vat polymerization method of the present invention combines the chemical and structural diversity of ROMP with the speed of continuous AM.

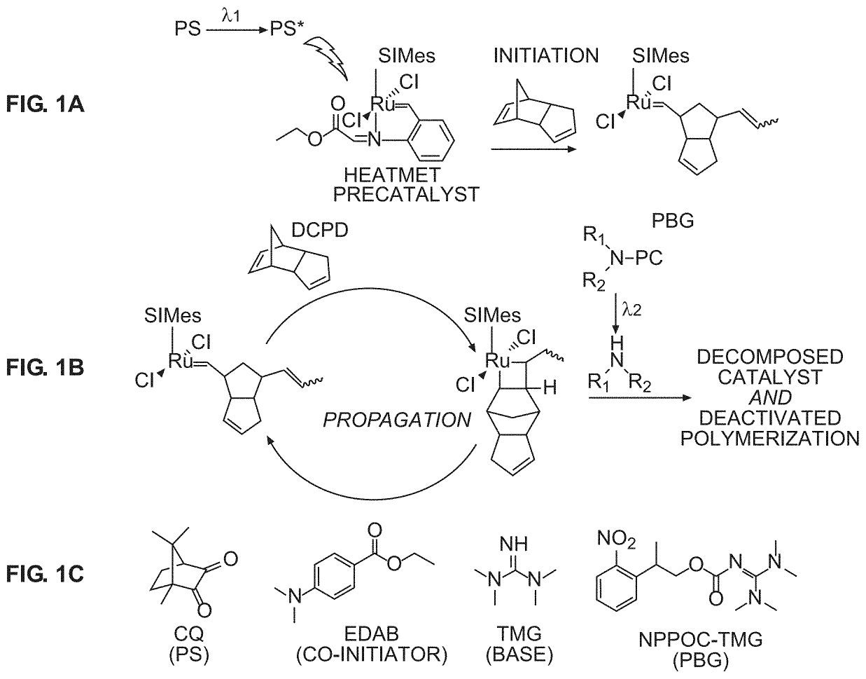

As shown in FIG. 1A, a photolatent (i.e., photo-active) metathesis catalyst can be used in combination with metathesis-active monomers or resins for photopolymerization-based additive manufacturing via ROMP. As such, HeatMet (HM) has recently been identified as a photolatent olefin metathesis catalyst to photopolymerize dicyclopentadiene (DCPD) under UV irradiation to yield a high-performance thermoset material. See S. C. Leguizamon et al, Chem. Mater. 33, 9677 (2021); J. A. Herman et al., ACS Appl. Polym. Mater. 1, 2177 (2019); U.S. application Ser. No. 17/677,558, filed Feb. 22, 2022; and U.S. application Ser. No. 17/803,632, filed Jun. 2, 2022, which are incorporated by reference herein. As described in U.S. application Ser. No. 17/677,558, the driving force of the ring-opening reaction metathesis-active DCPD monomer is relief of ring strain in the cyclic olefin. Therefore, pertinent metathesis-active monomers comprise cyclic olefins including, but not limited to, norbornadienes, norbornenes, oxonorbornenes, azanorbornenes, cyclobutenes, cyclooctenes, cyclooctadienes, cyclooctatetraenes, dicyclopentadiene, and derivatives and comonomers thereof. The most common photolatent metathesis catalysts for ROMP are Grubbs' catalysts. In addition to Ru-based catalysts, such as HM, other metathesis catalysts are based on other transition metals, such as W, Mo, Re, and Ti. Minimal polymerization occurs prior to activation of the photolatent metathesis catalyst by exposure to light. A photosensitizer (PS) can be used in the process to assist in the excitation of the photolatent metathesis catalyst. Photosensitizers and dyes that can be used include, but are not limited to, 2-isopropylthioxanthone (ITX) and camphorquinone (CQ), benzophenone, phenothiazine, benzil, Rose Bengal (RB), rhodamine derivatives, anthracene, perylene, and coumarins. These different PSs allow for multi-wavelength approaches to AM as each absorbs at different wavelengths. In some cases, a co-initiator, such as ethyl 4-(dimethylamino)benzoate (EDAB), can be added to accelerate the rate of initiation of the PS.

According to the present invention, a photolatent metathesis catalyst can be used in combination with a photochemical deactivating species to adapt a metathesis catalyst/monomer system to a dual-wavelength photo-activation/photo-deactivation approach. For example, the photochemical deactivating species can comprise a photobase generator (PBG) or a photo-induced radical inhibitor. In particular, Ru-based metathesis catalysts are susceptible to degradation via metallacyclobutane deprotonation using phosphines or amines; thus, PBG photolysis can be leveraged to mediate polymerization deactivation. See D. L. Nascimento et al., ACS Catal. 10, 11623 (2020). The use of a dual-wavelength approach enables volumetric patterning while simultaneously fostering rapid printing speeds. In particular, the invention uses selective dual-wavelength olefin metathesis polymerization (SWOMP) to implement continuous SLA. Based on the versatility of ROMP and the broad scope of chemistries amenable to polymerization, as well as the high impact strength and excellent chemical and thermal resistance of olefin thermosets, this invention enables the creation of bespoke printed components with applications ranging from automotive or aerospace components to membranes to degradable materials. See J. C. Mol, J. Mol. Catal. A: Chem. 213, 39 (2004); A. Mitchell et al., Add. Manuf. 24, 606 (2018); S. Kovačič and C. Slugovc, Mater. Chem. Front. 4, 2235 (2020); and D. Sathe et al., Nat. Chem. 13, 743 (2021).

The implementation of SWOMP requires the development of photo-orthogonal initiation and deactivation chemistries relevant to metathesis, as shown in FIG. 1B. In this method, irradiation of the photolatent metathesis catalyst with a first light at a first wavelength, Ai, will promote initiation of polymerization while irradiation of the PBG with a second light at a second wavelength, λ₂, will decompose the catalyst and thus deactivate polymerization. Polymerization deactivation as used herein refers to a dramatic cessation of monomer conversion. For SWOMP with PBGs, deactivation is mediated by catalyst decomposition and reduction of the overall concentration of propagating catalyst species and re-activation by initiation of further catalyst. Previous work by Lemcoff and co-workers has demonstrated two-wavelength olefin metathesis; however, deep UV light and long irradiation times were required for catalyst decomposition—conditions that are unsuitable for AM applications. See O. Eivgi et al., ACS Catal. 10, 2033 (2020); and R. L. Sutar et al., Angew. Chem. Int. Ed. 55, 764 (2016). To create a deactivation layer via PBG irradiation, the kinetics of deactivation—a two-step process involving photolysis of a PBG and subsequent reaction of the liberated base with the active catalytic species—would have to compete with the rates of catalyst initiation and propagation to effectively inhibit curing. The overall polymerization rate profile also needs to be considered, as this factor is directly related to the maximum printing speed that can be achieved. Thus, several parameters require optimization: initiator absorption wavelength, initiation rate, PBG absorption wavelength, decomposition/deactivation chemistry, and overall polymerization kinetics. The latter is primarily determined by catalyst identity and monomer concentration, and these were fixed across all experiments described herein. The other parameters were systematically evaluated by conducting polymerizations using resins formulated with different PSs, PBGs, and stoichiometries. As an example, DCPD was chosen as primary resin component based on its high ring strain and the excellent thermomechanical properties of its resulting material; 5-ethylene-2-norbornene (ENB) was used as a comonomer to depress the melting point of the mixture to produce a low-viscosity printing resin and allow rapid liquid infill, as resin viscosity is a key factor in achieving maximum printing rates. See I. D. Robertson et al., Nature 557, 223 (2018). M. P. de Beer et al., Sci. Adv. 5, eaau8723 (2019).

As a representative DCPD resin formulation, DCPD/ENB mixtures were first prepared at 5 wt % ENB by adding DCPD melted at 40-50° C. to a glass jar containing ENB and agitating until fully mixed. Photopolymerizable resin was then formulated using the DCPD/ENB mixture as follows: to a 125 mL Thinky™ cup was added 20 mg of HM (0.030 mmol, 1 equiv), 200 mg of CQ (1.2 mmol, 40 equiv), 400 mg of EDAB (2.1 mmol, 70 equiv), and 140 mg of NPPOC-TMG (0.45 mmol, 15 equiv). CH₂Cl2 was added in portions (˜1 mL total volume) to fully homogenize these components, consistent with established literature procedures. See C. Theunissen et al., J. Am. Chem. Soc. 141, 6791 (2019); O. Eivgi et al., ACS Catal. 10, 2033 (2020); O. Eivgi et al., ACS Catal. 11, 703 (2021); and R. Weitekamp et al., U.S. Pat. No. 10,799,613, issued Oct. 13, 2020. 20 g of DCPD/ENB mixture was then added, and the resin was agitated to homogenize. The photoresin was used immediately after preparation. The chemical structures of the exemplary components are shown in FIG. 1C.

To modulate initiator absorption profile and initiation rate, CQ, ITX, and benzil were evaluated as PSs for HM and EDAB was used as a co-initiator. Polymerizations were carried out in the presence of HM alone, HM+PS, or HM+PS+EDAB, and were monitored by FT-IR spectroscopy to determine monomer conversion and UV-rheology to measure cure behavior. Low conversion was obtained for HM in the absence of PS under the experimental conditions; however, addition of PS+EDAB resulted in increased conversion, polymerization rate, and gelation within the experimental timeframe. Additionally, the presence of PS facilitated the use of longer irradiation wavelengths to initiate the polymerizations. HM alone initiated most efficiently at 365 nm, whereas the polymerization could be initiated at 405 nm in the presence of ITX or benzil, or at 475 nm when using CQ.

Next, a series of amines (aniline, n-butylamine, cyclohexylamine, piperidine, and tetramethyl guanidine (TMG)) were evaluated for their capability to decompose the active HM-derived catalyst species. These amines were rationally selected to elucidate the influences of nucleophilicity and basicity on catalyst decomposition and were amenable to photo-caging (A photocage (PC) is a covalently bound photolabile protecting group that renders a molecule chemically inactive. Photolysis of the photocage releases the active molecule.) Two possible pathways of activity loss via catalyst decomposition by bases have been reported: (1) direct nucleophilic attack at the Ru carbene by phosphine or nitrogen, and (2) metallacyclobutane deprotonation. See S. H. Hong et al., J. Am. Chem. Soc. 129, 7961 (2007). Regardless of mechanism, treatment of Ru catalyst with excess amine was anticipated to trigger decomposition and polymerization deactivation. To evaluate this theory, polymerizations were carried out with the HM+Benzil+EDAB system in the presence of 1 equiv of amine under 405 nm light irradiation and monomer conversion was again monitored by FT-IR spectroscopy. Amine nucleophilicity did not appear to influence monomer conversion or conversion rate, as evident in comparisons of amines of similar basicity (i.e., n-butylamine, cyclohexylamine, and piperidine). In contrast, monomer conversion was observed to decrease linearly with increasing pKa, with TMG acting as the most efficient decomposer/deactivator.

Further insight into the deactivating effect of amines was gained using UV-vis spectroscopy. HM was mixed with 10 equiv TMG in dichloroethane solution in the presence or absence of monomer. Norbornene (NBE) was utilized as the monomer in this case to prevent gelation within the cuvette. No catalyst decomposition was observed in the presence of TMG either in the dark or with 365 nm irradiation, and polymerization readily occurred in the absence of TMG under 405 nm irradiation. In contrast, a decrease in the absorbance at λ˜320 nm associated with the metal ligand charge transfer (MLCT) band signified carbene loss when HM, NBE, and TMG were all mixed and the light turned on. See M. S. Sanford et al., J. Am. Chem. Soc. 123, 6543 (2001). Moreover, no polymerization was evident under these conditions. These data suggest that amine basicity determined decomposition and deactivation efficiency in this system and that catalyst initiation was required before decomposition could occur. Both factors pointed towards metallacyclobutane deprotonation as the primary mechanism of catalyst decomposition. TMG was utilized as the deactivating species in subsequent experiments based on superior efficiency.

PBGs supply a steady concentration of base—typically an amine—via photolysis of a protecting group. Of the numerous photo-protecting groups reported, nitrobenzyl derivatives are perhaps the most versatile and synthetically accessible. See P. Klan et al., Chem. Rev. 113, 119 (2013); M. J. Hansen et al., Chem. Soc. Rev. 44, 3358 (2015); X. Zhang et al., ACS Macro Lett. 7, 852 (2018); and W. Xi et al., Macromolecules 47, 6159 (2014). These compounds typically undergo photolysis upon irradiation with UV light, and their release half-lives can be tuned via chemical modification. A series of three PBGs were synthesized based on the 2-nitrobenzyl moiety and using TMG as the base: 2-nitrobenzyl TMG carbamate (NB-TMG), 4,5-dimethoxy-2-nitrobenzyl TMG carbamate (NVOC-TMG), and 2-(2-nitrophenyl)propyl TMG carbamate (NPPOC-TMG). UV-vis spectra indicate minimal absorbance at 405 nm, necessary for dual-wavelength selectivity with the chosen PSs.

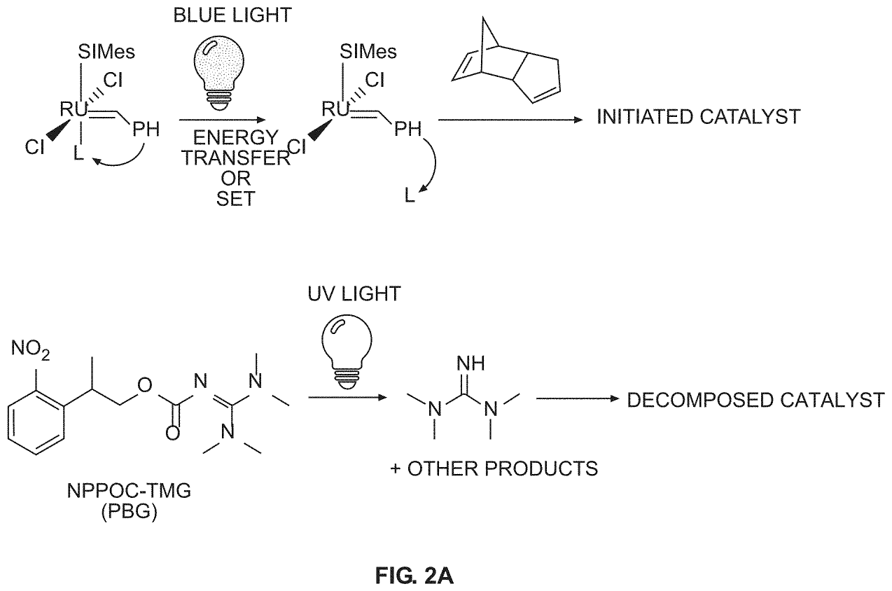

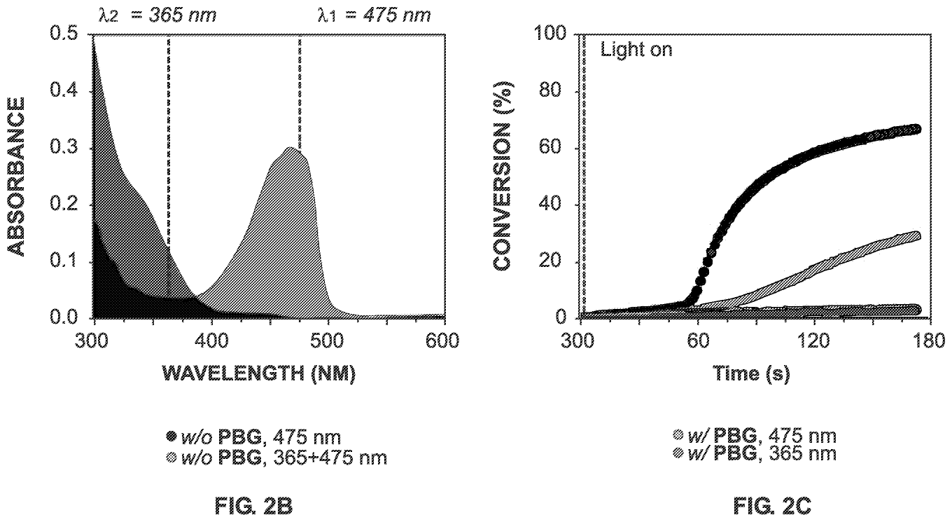

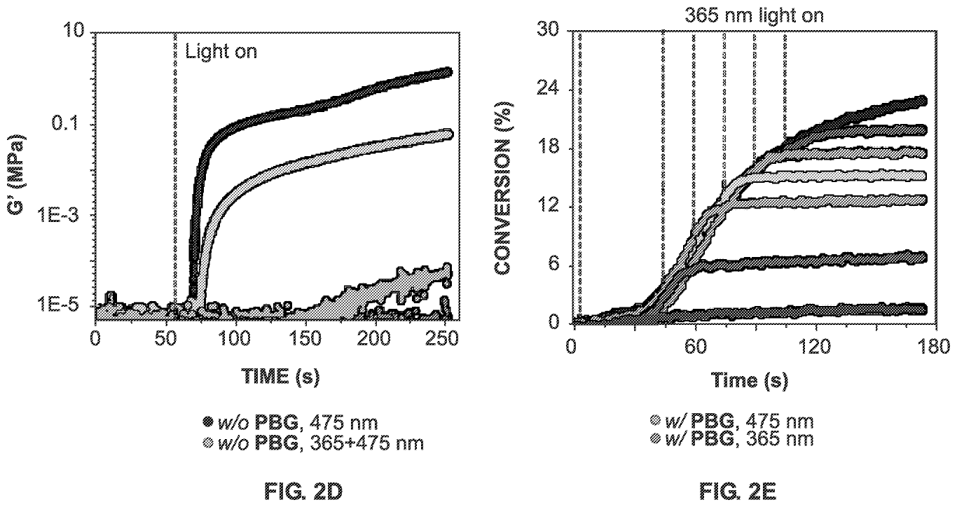

To evaluate the orthogonality of the various PSs and PBGs, FT-IR spectroscopy and UV-rheology were used to monitor polymerization progress of DCPD by HM in combination with a PS and a PBG. Experiments were conducted under 365 nm irradiation to ensure efficient decomposition and deactivation, 405/475 nm irradiation (depending on the PS) to evaluate the influence of the PBGs on catalyst initiation, or both 365 nm and 405/475 irradiation to simulate the environment of the deactivation layer under printing conditions. Ideally, the presence of PGB in the photoresin formulation would have little influence on the rate and ultimate conversion of the polymerization under 405/475 light irradiation, whereas 365 nm light irradiation (or a combination of both initiation and decomposition wavelengths) would act to deactivate polymerization. All PBGs were found to effectively inhibit polymerization when 365 nm or a combination of 365+405/475 nm light were used, regardless of the selected PS. Limited deactivation was observed in all cases when exclusively irradiated at 405/475 nm, likely attributable to partial sensitization of the PBG by the respective PS. See X. Zhang et al., ACS Macro Lett. 7, 852 (2018); and X. Zhang et al., Macromolecules 50, 5652 (2017). However, NPPOC-TMG had the least significant influence on monomer conversion under initiating conditions, and resin formulation with this PBG possessed the shortest incubation time for the onset of gelation. Based on these findings, and the relatively higher absorption maximum of CQ relative to the other PSs, the CQ+EDAB+NPPOC-TMG resin system, shown in FIG. 2A, was explored further.

Additional optimization experiments were carried out by varying formulation stoichiometry. The relative quantities of CQ, EDAB, and NPPOC-TMG were systematically varied, with [CQ]/[EDAB]/[NPPOC-TMG]/[HM]=10:20:15:1 giving the most optimal performance in terms of polymerization rate under 475 nm irradiation and deactivation efficiency with the 365 nm light on. How rapidly the DCPD polymerizations became deactivated by 365 nm irradiation was also investigated. Additional kinetic experiments were carried out using either 5, 10, or 15 equiv of NPPOC-TMG and followed by FT-IR spectroscopy. For this series, 475 nm light was turned on at the onset to initiate polymerization and then a 365 nm light source was turned on at various times in separate experiments to decompose the catalyst and thus deactivate polymerization. As shown in FIG. 2E, monomer conversion in the presence of 5 equiv NPPOC-TMG was arrested 20 s after the 365 nm light was turned on (conversion plateaued with near-zero additional conversion), while the 10 equiv NPPOC-TMG series responded within ca. 10 s and the 15 equiv series almost instantaneously. The ultimate conversions achieved in each case could be correlated to the time at which the 365 nm light was turned on and tended to decrease with increasing NPPOC-TMG loadings. The fact polymerization could be rapid turned off when using 15 equiv of NPPOC-TMG suggested that both high print resolution and print speed could be achieved using SWOMP chemistry.

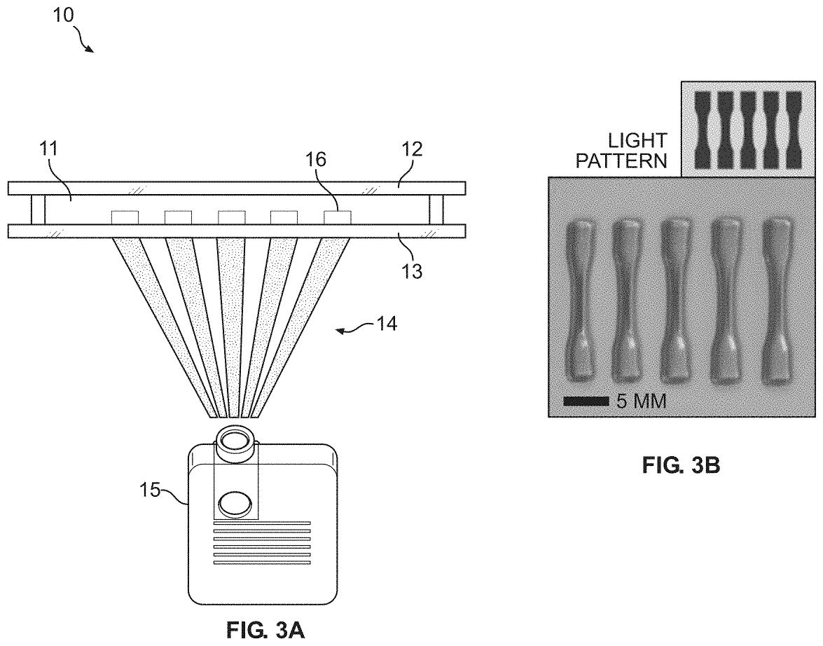

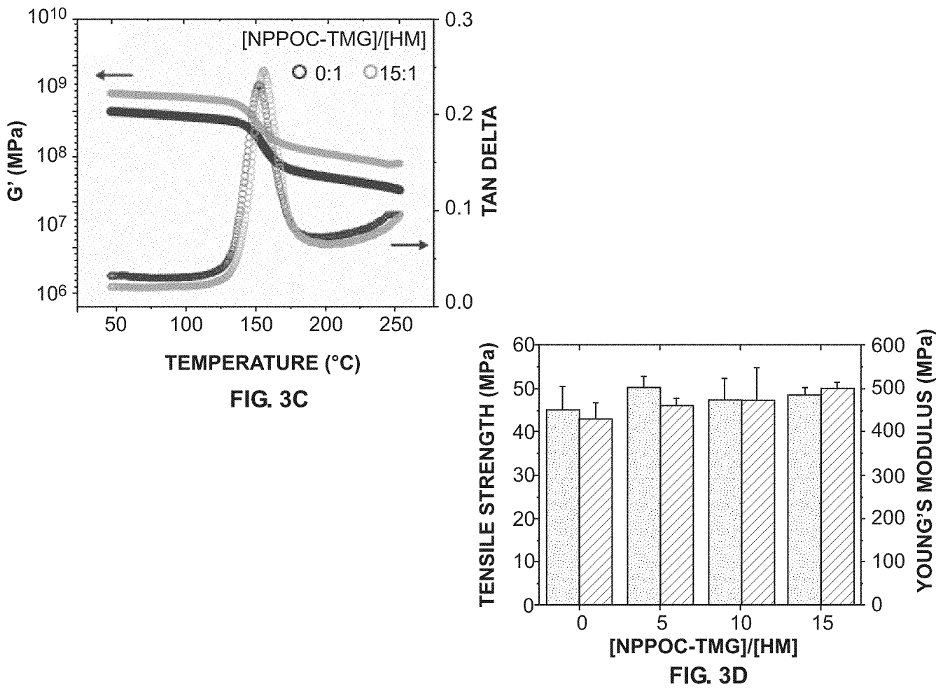

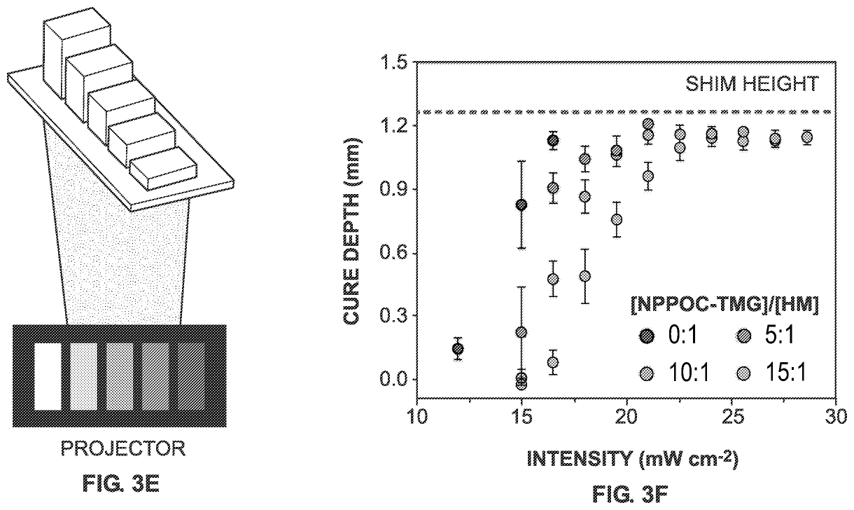

The presence of PBG and its concentration might adversely affect the mechanical properties of the cured materials. Therefore, pDCPD dogbones for use in mechanical testing were produced in a simulated printing environment using resin formulations with different loadings of NPPOC-TMG. This single-wavelength ROMP setup 10, shown in FIG. 3A, involved the containment of the photopolymerizable resins 11 between two glass slides 12 and 13. The resins 11 were then exposed to an image of patterned blue light 14 from a Digital Light Processing (DLP) projector 15 for 120 s, yielding cured parts 16 with 3D dogbone geometries, as shown in FIG. 3B. Polymer films were also produced using this method by projecting a large, rectangular image into the resin beds. The as-printed objects were subjected to post-cure at 250° C. for 30 min prior to analysis to fully consume unreacted DCPD monomer. Thermal post-cure is commonly employed for parts produced via DCPD polymerization and generally results in significantly higher glass transition values and improved mechanical performance. See S. C. Leguizamon et al, Chem. Mater. 33, 9677 (2021); and Z. Yao et al., J. Appl. Polym. Sci. 125, 2489 (2012). As shown in FIG. 3C, the presence of NPPOC-TMG had no detrimental influence on glass transition temperature, T_{g}, or temperature-dependent storage modulus. Moreover, dogbones produced with variable NPPOC-TMG loadings possessed nearly identical tensile strength and Young's modulus values compared with control samples that were cured without PBG, as shown in FIG. 3D. An additional advantage of DCPD polymerization via a ring-opening mechanism is reduced shrinkage during cure. An average volumetric shrinkage value of 7±2% was measured for photo-cured pDCDP parts, consistent with volumetric shrinkage values for pDCPD reported in the literature and significantly lower than the cure shrinkage of competing thermoset materials (typically 5-20%). See S. Kovačič and C. Slugovc, Mater. Chem. Front. 4, 2235 (2020); K. i. Koseki et al., J. Photopolym. Sci. Technol. 26, 567 (2013); and N. Liu et al., J. Micro/Nanolithogr., MEMS, MOEMS 12, 023005 (2013).

Cure depth defines the depth to which light penetrates and cures the resin. Control over this parameter, in combination with deactivation height, underpins optimization of printing rates and must be known to minimize cure-through when printing complex geometries. See M. P. de Beer et al., Sci. Adv. 5, eaau8723 (2019); and Z. D. Pritchard et al., Adv. Mater. Technol. 4, 1900700 (2019). Measurements to determine cure depth in this system were performed by projecting a gradient intensity image into the resin that produced a staircase-like structure, as shown in FIG. 3E, for which cured heights could be measured relative to the glass slide used as a projection window. Manipulation of cure depth could be readily achieved by varying both the incident light intensity and the concentration of NPPOC-TMG in the resin formulations, as shown in FIG. 3F, with higher blue light intensities increasing the depth of cure and higher NPPOC-TMG loadings affecting the opposite result.

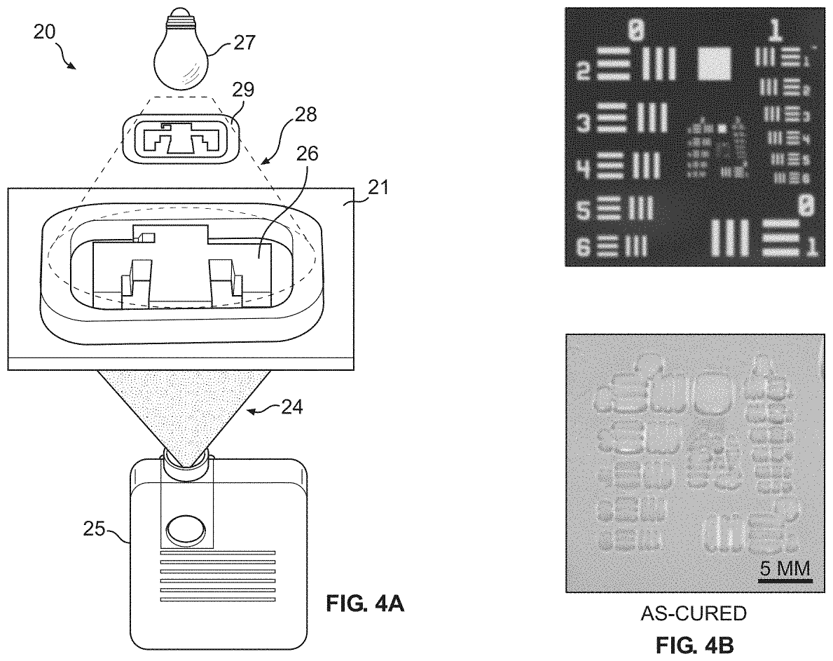

The data shown in FIGS. 3A-3F exemplify the scope of photocuring using a single color; however, the addition of a second wavelength enables catalyst deactivation chemistry and thereby expands the capabilities of the photocuring system, as by the dual-wavelength SWOMP setup 20 shown in FIG. 4A. As a simple demonstration, 2D geometries were readily produced using dual-wavelength stereolithography. For these experiments, the liquid photopolymerizable resin 21 was illuminated with an un-patterned background of blue light 24 from a projector 25 below, and light from a UV light source 27, positioned above the resin 21, was patterned 28 using a photomask 29. Areas of resin 26 exposed exclusively to blue light cured (i.e., areas where the UV light was blocked by the photomask), whereas those regions additionally exposed to UV light did not cure and the residual resin was readily washed away. Complex shapes and features on the sub-mm scale could be achieved using this method.

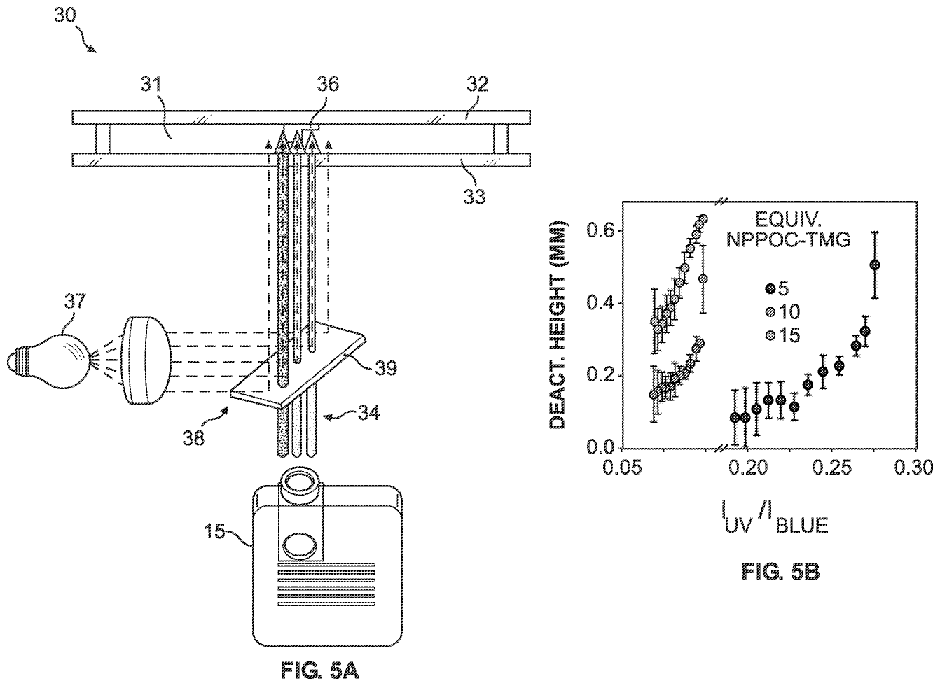

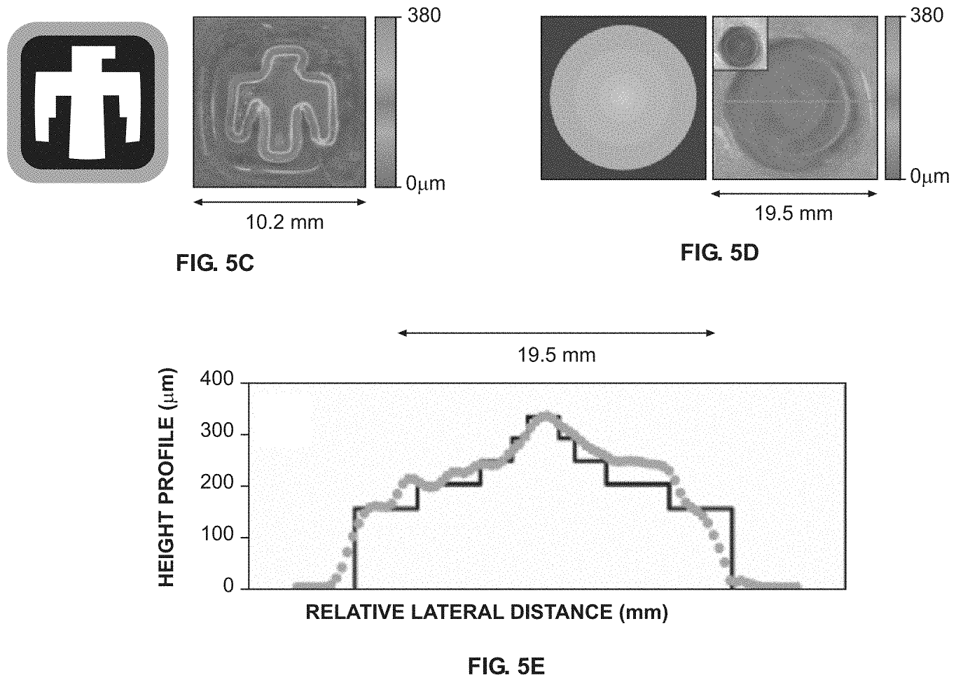

When the resin is exposed to both UV and blue light from the same direction, a deactivation volume or layer is created adjacent to the polymerization window in which polymerization does not occur. The thickness of this volume is defined by ratio of intensity of the two light sources and its geometry by the relative intensity at each point in space. See M. P. de Beer et al., Sci. Adv. 5, eaau8723 (2019). Both parameters can be controlled across a defined area and up to the maximum cure depth by projecting a patterned blue light image of variable intensity against an un-patterned UV background. FIG. 5A shows a schematic illustration of a dual-wavelength SWOMP setup 30, wherein a variable intensity image (grayscale image in this case) of patterned blue light 34 from a DLP projector 35 is superimposed upon a collimated light 38 from a UV light source 37 (e.g., a high-powered light emitting diode, LED) using a dichromic mirror 39 and then projected into the photopolymerizable resin 31. To quantify the relationship between the relative intensities of the two light colors and the height of the deactivation volume, the optimized resin was exposed to a combination of a gradient image of blue light, similar to the pattern utilized in the cure depth experiments, and un-patterned UV light such that the relative intensity of the two colors varied across the exposure area. As before, a staircase structure of cured material 36 was obtained. This time, however, the object was cured from the far-surface glass slide 32 as opposed to the projection window 33. The height at each step corresponded to the inverse of the deactivation height, which is shown as a function of intensity ratio in FIG. 5B. Here, the deactivation height appeared to scale exponentially with increased UV/blue light ratio, with higher UV light intensity needed for lower NPPOC-TMG loadings. As such, printing rates could theoretically be controlled during continuous SWOMP by tuning the PBG concentration and/or the ratio of incident light intensities. See M. P. de Beer et al., Sci. Adv. 5, eaau8723 (2019).

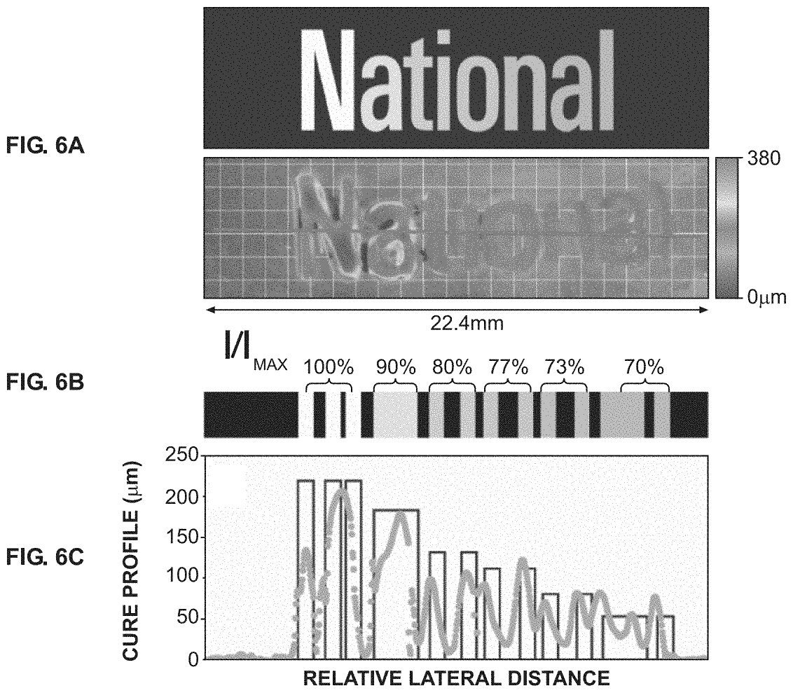

A unique feature of dual-wavelength SLA is the capability to produce complex 3D far-surface features in a single exposure. As shown in FIG. 5B, the volume of the deactivation layer can be directly controlled via the UV/blue light intensity ratio. This was exploited to produce a staircase structure (vide supra). More complex structures can be readily achieved by simply changing the grayscale image used to project the blue light, which affects spatial control over the relative intensities of UV and blue light incident on each region of the resin. Multilayer “Thunderbird” and “wedding cake” objects were produced from a single grayscale image with gradient shading (FIGS. 5C and 5D). Heights for the various layers, as determined by profilometry, closely matched expected values calculated using the deactivation height values, as shown in FIG. 5E. This process was amenable to complex images, as demonstrated by the SLA printing of variable height text, as shown in FIGS. 6A-6C. SLA printing of yet more complex objects can be achieved simply by converting images to grayscale and projecting them into the resin.

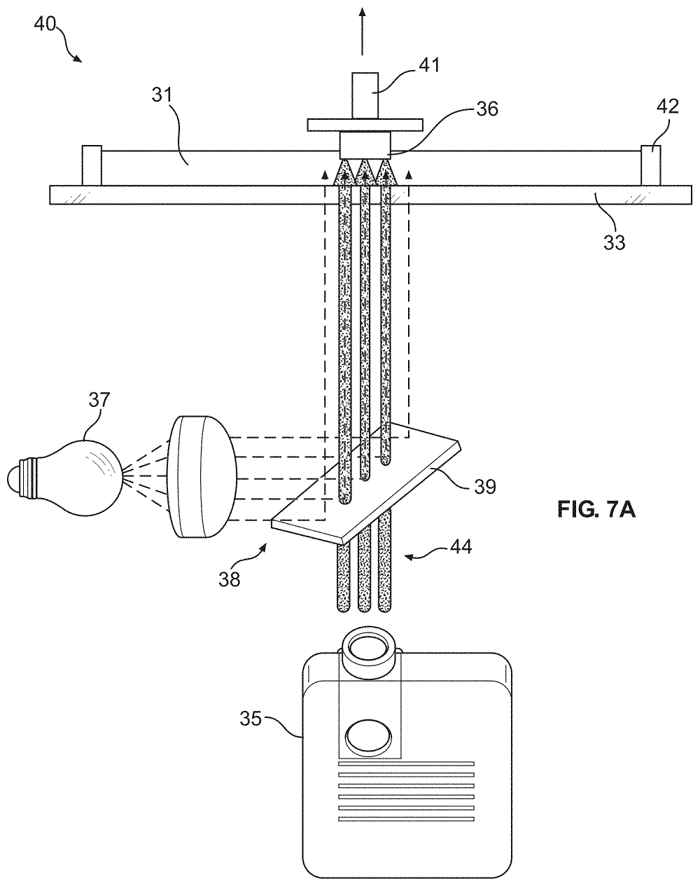

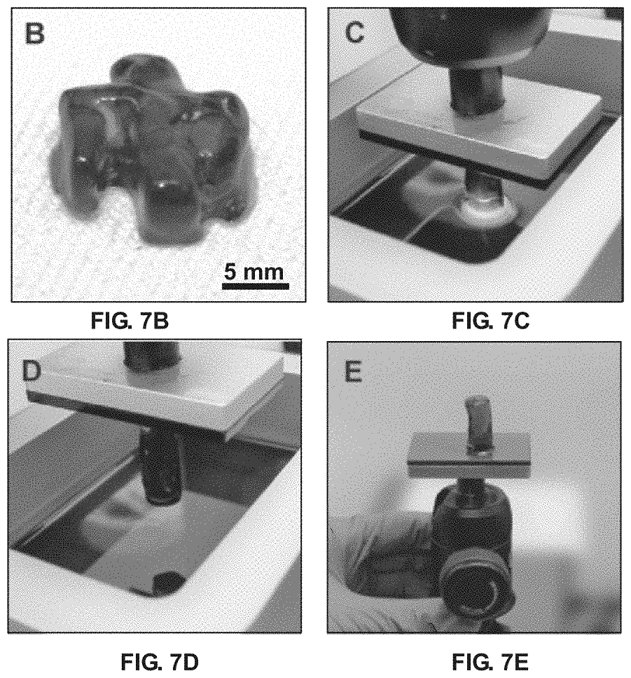

As a proof of concept, continuous SLA was demonstrated using the dual-wavelength SWOMP system 40, as shown in FIG. 7A. Here, a build head 41 was submerged into a vat 42 of photopolymerizable resin 31 using a similar illumination setup to the grayscale printing experiments shown in FIG. 7A. Again, patterned blue light 44 (which can also have a variable intensity image, as shown in FIG. 5A) from a DLP projector 35 is combined with collimated light 38 from a UV light source 37 using a dichromic mirror 39 and then projected into the photopolymeizable resin 31 through a projection window 33. The build head 41 can be continuously withdrawn from the vat of the photopolymerizable resin as the resin is cured, thereby producing a 3D object 36. The intensity and/or patterning of the blue light can be varied as the cured resin is withdrawn.

For the experiments, an initial resin height of ˜3 mm was used, which was >10× the thickness of the deactivation layer under the experimental conditions, as determined previously. To produce a 3D object, patterned blue light (30 mW cm⁻²) was superimposed against a UV flood (1.75 mW cm⁻²) and projected into the resin. The build head was then withdrawn at a rate of 36 mm h⁻¹ to produce a 4 mm thick “Thunderbird” object, as shown in FIG. 7B. This rate was determined to be optimal based on the measured intensity of the incident blue light. To further increase printing speed, the blue light projector and UV sources were replaced with an un-patterned, multi-wavelength, high intensity light source (475 nm @ 220 mW cm⁻² and 365 nm @ 80 mW cm⁻²). Here, a 27 mm tall cylindrical object was produced at a rate of 180 mm h⁻¹ during continuous SWOMP, as shown in FIGS. 7C-7E. Notably, this printing speed is substantially faster than conventional SLA. See M. P. de Beer et al., Sci. Adv. 5, eaau8723 (2019); and J. R. Tumbleston et al., Science 347, 1349 (2015).

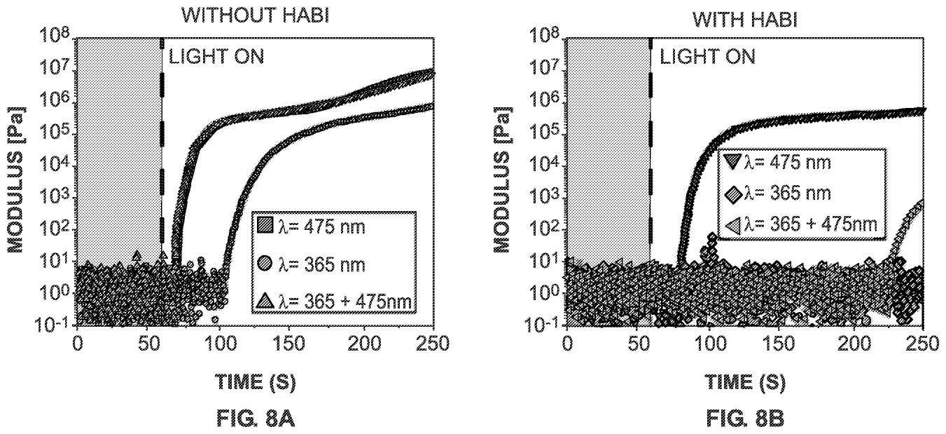

In addition to PBGs, the photochemical deactivating species can be a photo-induced radical inhibitor, such as hexaarylbiimidazole (HABI) or derivatives thereof. Other radical inhibitors include butyl nitrite and tetraethyl thiuram disulfide, for example. FIGS. 8A and 8B show polymerization evolution of modulus over time for DCPD resins without and with HABI, respectively. Evolution of modulus was characterized by photo-rheology using distinct irradiation profiles (475 nm only, 365 nm only, and concurrent 475 and 365 nm irradiation). [DCPD]/HM]=2000:1 was used for these experiments with 1 wt % CQ, 2 wt % EDAB and 1 wt % HABI (if used). It is apparent that the presence of HABI inhibits DCPD polymerization when the DCPD resin is irradiated with 365 nm light. However, the deactivating mechanism for the radical inhibitors may be different than that of the PBGs and likely involves reaction with the photosensitizer rather than directly with the catalyst.

The present invention has been described as selective dual-wavelength olefin metathesis polymerization for additive manufacturing. It will be understood that the above description is merely illustrative of the applications of the principles of the present invention, the scope of which is to be determined by the claims viewed in light of the specification. Other variants and modifications of the invention will be apparent to those of skill in the art.

We claim:

1. A photopolymerizable resin, comprising:
a metathesis-active monomer;
a photolatent metathesis catalyst;
a photosensitizer that initiates the photolatent metathesis catalyst upon irradiation with a first light at a first wavelength, thereby catalyzing the ring-opening metathesis polymerization of the metathesis-active monomer; and
a photochemical deactivating species that deactivates polymerization of the metathesis-active monomer upon irradiation with a second light at a second wavelength.

2. The photopolymerizable resin of claim 1, wherein the metathesis-active monomer comprises a cyclic olefin.

3. The photopolymerizable resin of claim 1, wherein the metathesis-active monomer comprises dicyclopentadiene, norbornadiene, norbornene, oxonorbornene, azanorbornene, cyclobutene, cyclooctene, cyclooctadiene, cyclooctatetraene, or derivatives or comonomers thereof.

4. The photopolymerizable resin of claim 1, wherein the photolatent metathesis catalyst comprises ruthenium.

5. The photopolymerizable resin of claim 4, wherein the ruthenium catalyst comprises HeatMet.

6. The photopolymerizable resin of claim 1, wherein the photolatent metathesis catalyst comprises tungsten, molybdenum, rhenium, or titanium.

7. The photopolymerizable resin of claim 1, wherein the photosensitizer comprises isopropylthioxanthone, camphorquinone, benzophenone, phenothiazine, benzil, Rose Bengal, rhodamine, anthracene, perylene, or coumarin.

8. The photopolymerizable resin of claim 1, further comprising a co-initiator.

9. The photopolymerizable resin of claim 9, wherein the co-initiator comprises ethyl-4-(dimethylamine), a benzoate tertiary amine, a heteroaromatic thiol, an alcohol, or a phosphorus-containing compound.

10. The photopolymerizable resin of claim 1, wherein the photochemical deactivating species comprises a photobase generator that reacts with the initiated metathesis catalyst upon irradiation with the second light at the second wavelength, thereby decomposing the metathesis catalyst and deactivating polymerization of the metathesis-active monomer.

11. The photopolymerizable resin of claim 10, wherein the photobase generator comprises an amine or phosphine.

12. The photopolymerizable resin of claim 11, wherein the amine comprises aniline, n-butylamine, cyclohexylamine, piperidine, or tetramethyl guanidine (TMG).

13. The photopolymerizable resin of claim 12, wherein the TMG comprises 2-nitrobenzyl TMG carbamate (NB-TMG), 4,5-dimethoxy-2-nitrobenzyl TMG carbamate (NVOC-TMG), or 2-(2-nitrophenyl)propyl TMG carbamate (NPPOC-TMG).

14. The photopolymerizable resin of claim 1, wherein the photochemical deactivating species comprises a photo-induced radical inhibitor.

15. The photopolymerizable resin of claim 14, wherein the photo-induced radical inhibitor comprises hexaarylbiimidazole or a derivative thereof.

16. The photopolymerizable resin of claim 14, wherein the photo-induced radical inhibitor comprises butyl nitrite, tetraethyl thiuram disulfide, or derivatives thereof.

17. A method for photopolymerization-based additive manufacturing, comprising
providing a vat of the photopolymerizable resin of claim 1,
irradiating the photopolymerizable resin with the first light at the first wavelength, wherein irradiation with the first light initiates the ring-opening metathesis polymerization of the metathesis-active monomer, and
irradiating the photopolymerizable resin with the second light at the second wavelength, wherein irradiation with the second light deactivates polymerization of the metathesis-active monomer, and
wherein the photopolymerizable resin is selectively irradiated with the first light and the second light so as to form a cured object.

18. The method of claim 17, wherein the first light is patterned, thereby providing patterned illumination of the photopolymerizable resin.

19. The method of claim 18, wherein the patterned first light has a variable intensity image.

20. The method of claim 17, wherein the second light is patterned, thereby providing patterned illumination of the photopolymerizable resin.

21. The method of claim 20, wherein the patterned second light has a variable intensity image.

22. The method of claim 17, wherein the cured object is continuously withdrawn from the vat, thereby forming a three-dimensional object.

23. The method of claim 22, wherein the first light and/or the second light are patterned and wherein the pattern is varied as the cured object is continuously withdrawn from the vat.

24. The method of claim 22, wherein the first light and/or the second light has a variable intensity image and wherein the variable intensity image is varied as the cured object is continuously withdrawn from the vat.
